(19) United States
(12) Patent Application Publication
(10) Pub. No.: US 2026/0090500 A1
(43) Pub. Date: Apr. 2, 2026

(54) EXTRACTOR WITH MULTI-FUNCTION EXTRACTOR BLADES FOR AN AGRICULTURAL HARVESTER AND RELATED ASSEMBLIES AND HARVESTERS

(71) Applicant: CNH Industrial Brasil Ltda., Nova Lima (BR)

(72) Inventors: João Augusto Marcolin Lucca, Piracicaba-SP (BR); Ivan Luis Duarte Forti, Paulínia (BR); Jean Carlos Pereira De Camargo, Piracicaba-SP (BR)

(21) Appl. No.: 19/348,136

(22) Filed: Oct. 2, 2025

(30) Foreign Application Priority Data
Sep. 27, 2024 (BR) 10 2024 020005 5

(51) Int. Cl. A01D 43/08; A01D 45/10; A01D 61/00

(52) U.S. Cl. CPC A01D 43/086; A01D 45/10; A01D 61/00

(57) ABSTRACT

An extractor for an agricultural harvester includes an extractor housing extending from an extractor inlet to an extractor outlet. The extractor housing is configured to receive debris at the extractor inlet and direct the debris outwardly from the harvester at the extractor outlet. The extractor also includes an extractor blade assembly positioned within the extractor housing, with the assembly comprising a plurality of extractor blades. Each extractor blade includes a cutting portion and a suction portion. When the extractor blades are rotated in a rotational direction within the extractor housing, the suction portion of each extractor blade is configured to generate a suction force within the extractor housing for directing the debris from the extractor inlet to the extractor outlet; and the cutting portion of each extractor blade is configured to cut at least a portion of the debris being directed from the extractor inlet to the extractor outlet.

### CROSS-REFERENCE TO RELATED APPLICATIONS

The present application is based upon and claims the right of priority to BR Patent Application No. 102024 020005 5, filed September 27, 2024, the disclosure of which is hereby incorporated by reference herein in its entirety for all purposes.

### FIELD OF THE INVENTION

The present subject matter relates generally to agricultural harvesters, such as sugar cane harvesters, and, more particularly, to an extractor having multi-function extractor blades configured for use with an agricultural harvester as well as related systems and methods.

### BACKGROUND OF THE INVENTION

Typically, agricultural harvesters include one or more extractors configured to separate and remove pieces of debris or thresh from a stream of harvested crops, such as a stream of sugar cane billets. For example, a sugarcane harvester often includes a primary extractor positioned near an intake end of an elevator assembly that conveys crops toward a receiver collecting the crops, and a secondary extractor positioned near a discharge end of the elevator assembly. For conventional sugarcane harvesters, both the primary extractor and the secondary extractor include an axial flow extractor fan positioned directly in-line with the flow of debris through the extractor. For instance, the extractor fan typically includes a fan hub positioned in the center of the extractor, with fan blades extending radially outwardly from the hub. These fan blades are designed solely to generate a suction force that that extracts debris from the flow of crop flowing below the extractor fan.

Recently, extractors have been developed for sugarcane harvesters that incorporate leaf shredders as separate components from the extractor fan, with these debris shredders being intended solely to shred or cut the debris being transported through the extractor housing. For example, recent attempts have included placing fixed shredding knives along the inner perimeter of the extractor housing or providing a set of rotating shredding knives positioned above or below the extractor fan. In this regard, it would be advantageous to provide improvements or refinements over these prior designs, including less complex designs and/or designs that can be implemented in a more cost-effective and/or less resource-intensive manner.

Accordingly, an improved blade assembly for an extractor that allows for shredding or cutting of the debris being transported therethrough would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to an extractor for an agricultural harvester. The extractor includes an extractor housing extending from an extractor inlet to an extractor outlet. The extractor housing is configured to receive debris at the extractor inlet and direct the debris outwardly from the agricultural harvester at the extractor outlet. The extractor also includes an extractor blade assembly positioned within the extractor housing, with the extractor blade assembly comprising a plurality of extractor blades. Each extractor blade of the plurality of extractor blades includes a cutting portion and a suction portion. When the plurality of extractor blades are rotated in a rotational direction within the extractor housing, the suction portion of each extractor blade is configured to generate a suction force within the extractor housing for directing the debris from the extractor inlet to the extractor outlet; and the cutting portion of each extractor blade is configured to cut at least a portion of the debris being directed from the extractor inlet to the extractor outlet.

In another aspect, the present subject matter is directed to an extractor for an agricultural harvester. The extractor includes an extractor housing extending from an extractor inlet to an extractor outlet. The extractor housing is configured to receive debris at the extractor inlet and direct the debris outwardly from the agricultural harvester at the extractor outlet. The extractor also includes a rotational drive member extending along a rotational axis within the extractor housing and being configured to be coupled to a rotational drive source for rotationally driving the rotational drive member about the rotational axis. Additionally, the extractor includes an extractor blade assembly comprising a plurality of extractor blades coupled to and extending radially outward from the rotational drive member. Each extractor blade of the plurality of extractor blades includes first and second blade sections and a hub section extending between the first and second blade sections. The first blade section of each extractor blade includes a first cutting portion and a first suction portion and the second blade section of each extractor blade includes a second cutting portion and a second suction portion. The hub section of each extractor blade is coupled to the rotational drive member. When the plurality of extractor blades are rotated via rotation of the rotational drive member: the first and second suction portions of each extractor blade are configured to generate a suction force within the extractor housing for directing the debris from the extractor inlet to the extractor outlet; and the first and second cutting portions of each extractor blade are configured to cut at least a portion of the debris being directed from the extractor inlet to the extractor outlet.

In a further aspect, the present subject matter is directed to an agricultural harvester including a chopper assembly configured to process harvested materials, and an extractor configured to extract debris from a flow of processed harvested materials output from the chopper assembly. The extractor includes an extractor housing extending from an extractor inlet to an extractor outlet, with the extractor housing configured to receive the debris at the extractor inlet and direct the debris outwardly from the agricultural harvester at the extractor outlet. The extractor also includes an extractor blade assembly positioned within the extractor housing. The extractor blade assembly includes a plurality of extractor blades, with each extractor blade of the plurality of extractor blades having a cutting portion and a suction portion. When the plurality of extractor blades are rotated in a rotational direction within the extractor housing: the suction portion of each extractor blade is configured to generate a suction force within the extractor housing for directing the debris from the extractor inlet to the extractor outlet; and the cutting portion of each extractor blade is configured to cut at least a portion of the debris being directed from the extractor inlet to the extractor outlet.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a simplified, side view of one embodiment of an agricultural harvester in accordance with aspects of the present subject matter;

FIG. 2 illustrates a side view of a portion of the agricultural harvester shown in FIG. 1, particularly illustrating a schematic view of one embodiment of an extractor blade assembly installed within the primary extractor of the harvester in accordance with aspects of the present subject matter;

FIG. 3 illustrates a detailed, cross-sectional view of one embodiment of the extractor blade assembly shown in FIG. 2 in accordance with aspects of the present subject matter;

FIG. 4 illustrates a bottom, cross-sectional view of the extractor blade assembly shown in FIG. 3 taken about line 4-4 in accordance with aspects of the present subject matter;

FIG. 5 illustrates a perspective view of one embodiment of an extractor blade suitable for use within an extractor blade assembly in accordance with aspects of the present subject matter;

FIG. 6 illustrates a close-up, perspective view of a portion of the extractor blade shown in box 6-6 in FIG. 5 in accordance with aspects of the present subject matter; and

FIG. 7 illustrates a cross-sectional view of the portion of the extractor blade shown in FIG. 6 taken about line 7-7 in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to an extractor for an agricultural harvester, such as a sugarcane harvester, that includes multi-function extractor blades forming part of an extractor blade assembly. Specifically, in several embodiments, the extractor blades are design as dual-purpose blades configured to both: (1) generate a suction force within the extractor housing for directing debris through the housing; and (2) cut or shred the debris directed therethrough. For instance, as will be described below, each extractor blade may include both a suction portion and a cutting portion, with the suction portion design to generate the suction force and the cutting portion design to cut or shred debris. As a result, each extractor blade may function as both a fan blade and a cutting or shredding blade. This configuration allows for a simpler design when attempting to incorporate cutting or shredding into an extractor and also provides for a design that can be implemented in a more cost-effective and/or less resource-intensive manner than prior art designs.

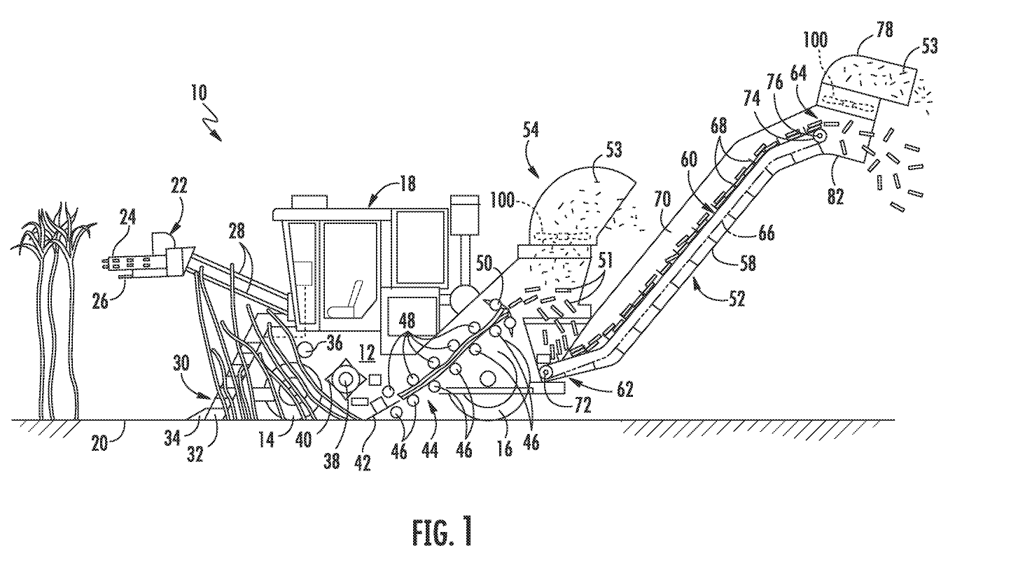

Referring now to the drawings, FIG. 1 illustrates a side view of one embodiment of an agricultural harvester 10 in accordance with aspects of the present subject matter. As shown, the harvester 10 is configured as a sugarcane harvester. However, in other embodiments, the harvester 10 may correspond to any other suitable agricultural harvester known in the art.

As shown in FIG. 1, the harvester 10 includes a frame 12, a pair of front wheels 14, a pair of rear wheels 16, and an operator's cab 18. The harvester 10 may also include a primary source of power (e.g., an engine mounted on the frame 12) which powers one or both pairs of the wheels 14, 16 via a transmission (not shown). Alternatively, the harvester 10 may be a track-driven harvester and, thus, may include tracks driven by the engine as opposed to the illustrated wheels 14, 16. The engine may also drive a hydraulic fluid pump (not shown) configured to generate pressurized hydraulic fluid for powering various hydraulic components of the harvester 10.

Additionally, the harvester 10 may include various components for cutting, processing, cleaning, and discharging sugar cane as the cane is harvested from an agricultural field 20. For instance, the harvester 10 may include a topper assembly 22 positioned at its front end to intercept sugar cane as the harvester 10 is moved in the forward direction. As shown, the topper assembly 22 may include both a gathering disk 24 and a cutting disk 26. The gathering disk 24 may be configured to gather the sugar cane stalks so that the cutting disk 26 may be used to cut off the top of each stalk. As is generally understood, the height of the topper assembly 22 may be adjustable via a pair of arms 28 hydraulically raised and lowered, as desired, by the operator.

Additionally, the harvester 10 may include a crop divider 30 that extends upwardly and rearwardly from the field 20. In general, the crop divider 30 may include two spiral feed rollers 32. Each feed roller 32 may include a ground shoe 34 at its lower end to assist the crop divider 30 in gathering the sugar cane stalks for harvesting. Moreover, as shown in FIG. 1, the harvester 10 may include a knock-down roller 36 positioned near the front wheels 14 and a fin roller 38 positioned behind the knock-down roller 36. As the knock-down roller 36 is rotated, the sugar cane stalks being harvested are knocked down while the crop divider 30 gathers the stalks from agricultural field 20. Further, as shown in FIG. 1, the fin roller 38 may include a plurality of intermittently mounted fins 40 that assist in forcing the sugar cane stalks downwardly. As the fin roller 38 is rotated during the harvest, the sugar cane stalks that have been knocked down by the knock-down roller 36 are separated and further knocked down by the fin roller 38 as the harvester 10 continues to be moved in the forward direction relative to the field 20.

Referring still to FIG. 1, the harvester 10 may also include a base cutter assembly 42 positioned behind the fin roller 38. As is generally understood, the base cutter assembly 42 may include blades (not shown) for severing the sugar cane stalks as the cane is being harvested. The blades, located on the periphery of the assembly 42, may be rotated by a hydraulic motor (not shown) powered by the vehicle’s hydraulic system. Additionally, in several embodiments, the blades may be angled downwardly to sever the base of the sugar cane as the cane is knocked down by the fin roller 38.

Moreover, the harvester 10 may include a feed roller assembly 44 located downstream of the base cutter assembly 42 for moving the severed stalks of sugar cane from the base cutter assembly 42 along the processing path. As shown in FIG. 1, the feed roller assembly 44 may include a plurality of bottom rollers 46 and a plurality of opposed, top pinch rollers 48. The various bottom and top rollers 46, 48 may be used to pinch the harvested sugar cane during transport. As the sugar cane is transported through the feed roller assembly 44, debris (e.g., rocks, dirt, and/or the like) may be allowed to fall through bottom rollers 46 onto the field 20.

In addition, the harvester 10 may include a chopper assembly 50 located at the downstream end of the feed roller assembly 44 (e.g., adjacent to the rearward-most bottom and top feed rollers 46, 48). In general, the chopper assembly 50 may be used to cut or chop the severed sugar cane stalks into pieces or “billets” 51 which may be, for example, six (6) inches long. The billets 51 may then be propelled towards an elevator assembly 52 of the harvester 10 for delivery to an external receiver or storage device (not shown).

As is generally understood, pieces of debris 53 (e.g., dust, dirt, leaves, etc.) separated from the sugar cane billets 51 may be expelled from the harvester 10 through a primary extractor 54, which is located behind the chopper assembly 50 and is oriented to direct the debris 53 outwardly from the harvester 10. Additionally, an extractor blade assembly 100 may be provided within the primary extractor 54 for both: (1) generating a suction force or vacuum sufficient to pick up the debris 53 and force the debris 53 through the primary extractor 54; and (2) cutting or shredding the debris as it is directed through the extractor 54. The cut or shredded debris 53 is then directed out of and away from harvester 10 via an outlet of the primary extractor 54. The separated or cleaned billets 51, heavier than the debris 53 being expelled through the extractor 54, may then fall downward to the elevator assembly 52.

As shown in FIG. 1, the elevator assembly 52 may generally include an elevator housing 58 and an elevator 60 extending within the elevator housing 58 between a lower, proximal end 62 and an upper, distal end 64. In general, the elevator 60 may include a looped chain 66 and a plurality of flights or paddles 68 attached to and evenly spaced on the chain 66. The paddles 68 may be configured to hold the sugar cane billets 51 on the elevator 60 as the billets 51 are elevated along a top span of the elevator 70 defined between its proximal and distal ends 62, 64. Additionally, the elevator 60 may include lower and upper sprockets 72, 74 positioned at its proximal and distal ends 62, 64, respectively. As shown in FIG. 1, an elevator motor 76 may be coupled to one of the sprockets (e.g., the upper sprocket 74) for driving the chain 66, thereby allowing the chain 66 and the paddles 68 to travel in an endless loop between the proximal and distal ends 62, 64 of the elevator 60.

Moreover, pieces of debris 53 (e.g., dust, dirt, leaves, etc.) separated from the elevated sugar cane billets 51 may be expelled from the harvester 10 through a secondary extractor 78 coupled to the rear end of the elevator housing 58. As shown in FIG. 1, the secondary extractor 78 may be located adjacent to the distal end 64 of the elevator 60 and may be oriented to direct the debris 53 outwardly from the harvester 10. Similar to the primary extractor 54, the secondary extractor 78 may also include an extractor blade assembly 100 for both: (1) generating a suction force or vacuum sufficient to pick up the debris 53 and force the debris 53 through the secondary extractor 78; and (2) cutting or shredding the debris as it is directed through the extractor 78. The separated, cleaned billets 51, heavier than the debris 53 expelled through the extractor 78, may then fall from the distal end 64 of the elevator 60. Typically, the billets 51 may fall downwardly through a discharge opening 82 of the elevator assembly 52 into an external storage device (not shown), such as a sugar cane billet cart.

During operation, the harvester 10 is traversed across the agricultural field 20 for harvesting sugar cane. After the height of the topper assembly 22 is adjusted via the arms 28, the gathering disk 24 on the topper assembly 22 may function to gather the sugar cane stalks as the harvester 10 proceeds across the field 20, while the cutter disk 26 severs the leafy tops of the sugar cane stalks for disposal along either side of harvester 10. As the stalks enter the crop divider 30, the ground shoes 34 may set the operating width to determine the quantity of sugar cane entering the throat of the harvester 10. The spiral feed rollers 32 then gather the stalks into the throat to allow the knock-down roller 36 to bend the stalks downwardly in conjunction with the action of the fin roller 38. Once the stalks are angled downwardly as shown in FIG. 1, the base cutter assembly 42 may then sever the base of the stalks from field 20. The severed stalks are then, by movement of the harvester 10, directed to the feed roller assembly 44.

The severed sugar cane stalks are conveyed rearwardly by the bottom and top feed rollers 46, 48, which compress the stalks, to make them more uniform, and shake loose debris to pass through the bottom rollers 46 to the field 20. At the downstream end of the feed roller assembly 44, the chopper assembly 50 cuts or chops the compressed sugar cane stalks into pieces or billets 51. Airborne debris or chaff 53 (e.g., dust, dirt, leaves, etc.) separated from the sugar cane billets 51 is then extracted/processed through the primary extractor 54 via the operation of the extractor blade assembly 100. The separated/cleaned billets 51 then fall downwardly into the elevator assembly 52 and travel upwardly via the elevator 60 from its proximal end 62 to its distal end 64. During normal operation, once the billets 51 reach the distal end 64 of the elevator 60, the billets 51 fall through the discharge opening 82 to an external storage device. Similar to the primary extractor 54, debris or chaff 53 is extracted/processed through the secondary extractor 78 with the aid of the associated extractor blade assembly 100.

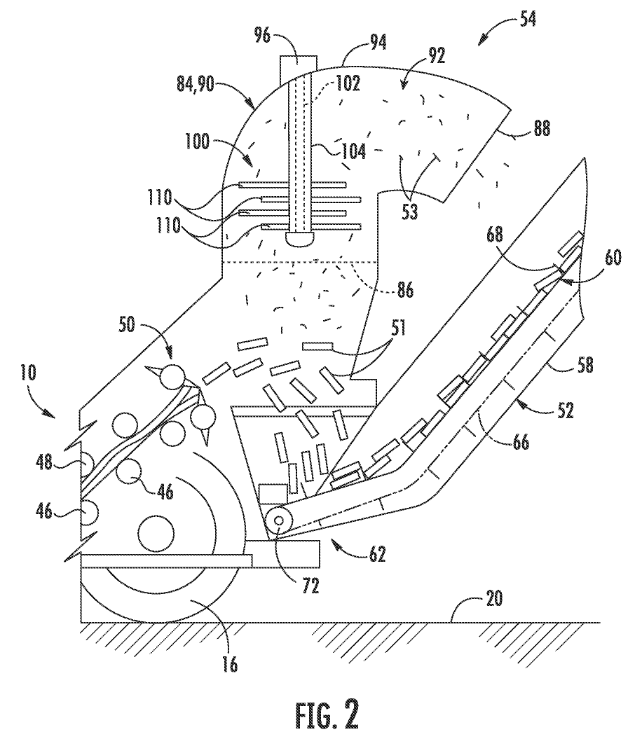

Referring now to FIG. 2, a partial side view of the agricultural harvester 10 shown in FIG. 1 is illustrated, particularly illustrating a schematic view of one embodiment of an extractor blade assembly 100 installed within the primary extractor 54 of the harvester 10 in accordance with aspects of the present subject matter. In general, the blade assembly 100 will be described herein with reference to being installed within a harvester’s primary extractor 54 (e.g., as a replacement for a typical primary extractor fan). However, in other embodiments, the disclosed blade assembly 100 may also be installed within a harvester’s secondary extractor 78 (e.g., as a replacement for a typical secondary extractor fan).

As shown in FIG. 2, the extractor 54 may generally include an extractor housing 84 extending from an extractor inlet (e.g., as indicated by dashed line 86 in FIG. 2) to an extractor outlet 88. The extractor housing 84 may include an exterior housing wall 90 extending around the outer perimeter of the housing 84 such that the housing 84 defines an airflow channel 92 between the extractor inlet 86 and outlet 88 for directing debris 53 through the housing 84 for subsequent discharge from the extractor 54 via the outlet 88. As such, debris 53 directed into the inlet 86 of the extractor housing 84 may flow through the airflow channel 92 prior to being discharged from the extractor 54 at the extractor outlet 88.

Additionally, as shown in FIG. 2, an extractor blade assembly 100 is positioned within the extractor housing 84. As will be described below, the blade assembly 100 may include various components, including, but not limited to, a rotational drive member (e.g., shaft 102), a drive member housing (e.g., shaft housing 104), and a plurality of extractor blades 110 (four of which are labeled in FIG. 2) coupled to and extending radially outwardly from the shaft 102, with the shaft 102 being configured to rotationally drive the extractor blades 110. As shown in FIG. 2, the blade assembly 100 may be installed within the extractor housing 84 such that the extractor blades 110 are positioned within the airflow channel 92 defined by the housing 84. For example, an upper portion of the shaft housing 104 may be coupled to a top portion 94 of the extractor housing 84 to allow the various assembly components to be suspended from or otherwise supported by the housing 84. Additionally, a rotational drive source 96, such as a hydraulic motor driven by the vehicle’s hydraulic system or any other suitable motor, may be installed along the top portion 94 of the extractor housing 84 (e.g., along the exterior of the top portion 94 of the housing 84) and may be rotationally coupled to the shaft 102. As such, the rotational drive source 96 may rotationally drive the shaft 102, which may, in turn, rotationally drive the extractor blades 110 to allow the blade assembly 100 to function as described herein. For instance, as will be described below, rotation of the extractor blades 110 may result in the generation of a suction force at the extractor inlet 86 that draws debris 53 upwardly away from the stream of billets 51 expelled from the chopper assembly 50 and into the airflow channel 92 defined by the extractor housing 84 for subsequent delivery to the extractor outlet 88. Additionally, given the cutting or shredding functionality of the extractor blades 110, such blades 110 may also cut or shred the debris 53 as it passes thereby.

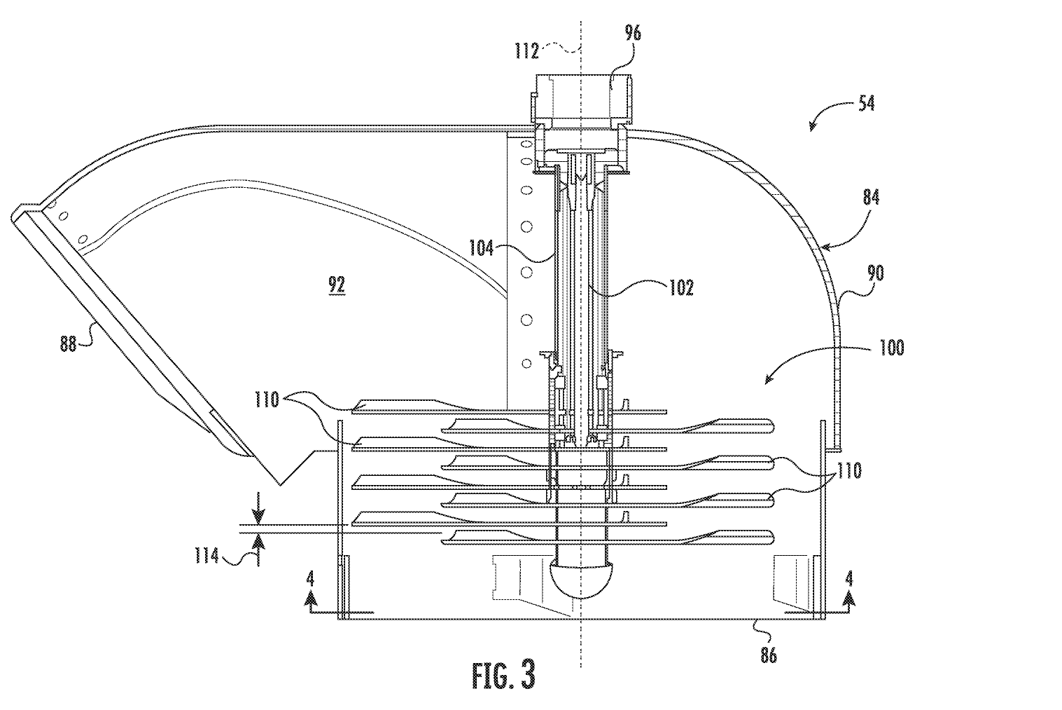

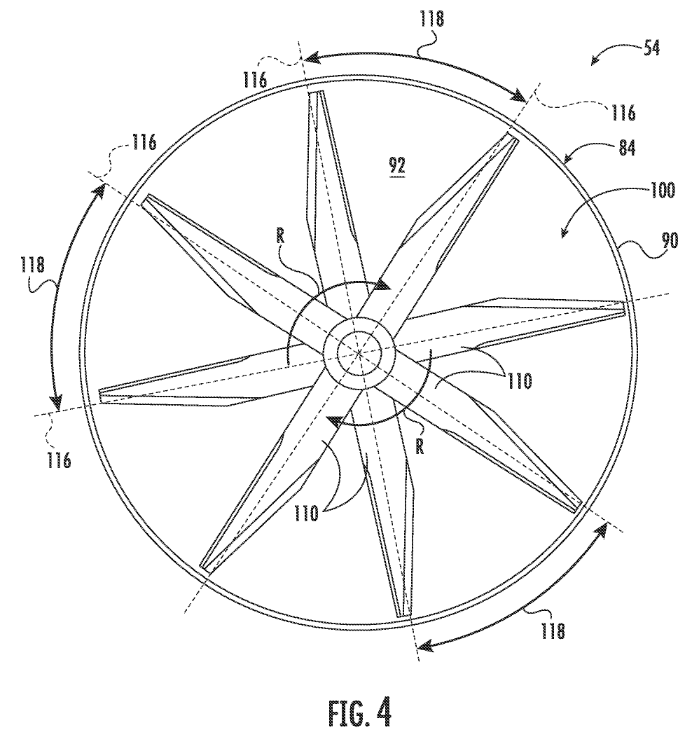

Referring now to FIGS. 3 and 4, different views of the primary extractor 54 described above are illustrated in accordance with aspects of the present subject matter. Specifically, FIG. 3 illustrates a cross-sectional view of the housing 84 of the primary extractor 54 with the extractor blade assembly 100 installed therein. Additionally, FIG. 4 illustrates a bottom, cross-sectional view of the extractor blade assembly 100 shown in FIG. 3 taken about line 4-4, particularly illustrating the extractor blade assembly 100 positioned within a bottom portion of the extractor housing 84.

As shown in FIGS. 3 and 4, the extractor blade assembly 100 may generally include a plurality of extractor blades 110 coupled to and extending radially outwardly from the assembly’s rotational drive member (e.g., shaft 102). For example, as particularly shown in FIG. 3, the extractor blade assembly 100 includes a set of eight extractor blades 110. However, in other embodiments, the extractor blade assembly 100 may include any other suitable number of extractor blades 110, such as seven or fewer extractor blades 110 (e.g., 2, 3, 4, 5, 6, or 7 extractor blades) or nine or greater extractor blades 110 (e.g., 9, 10, 11, 12, or greater extractor blades).

In several embodiments, the various extractor blades 110 of the extractor blade assembly 100 may be configured to be axially arranged along an axial section or portion of the extractor shaft 102. Specifically, as shown in FIG. 3, the extractor blades 110 are axially stacked or arranged along a rotational axis 112 of the shaft 102 such that a given axial spacing 114 is defined between adjacent extractor blades 110. In one embodiment, the axial spacing 114 may be selected so as to relatively small such that adjacent extractor blades 110 are positioned generally adjacent to one another. For instance, in one embodiment, the axial spacing 114 defined between adjacent extractor blades 110 may be less than 3 inches, such as less than 2 inches, or less than 1 inch, or less than 0.5 inches or less than 0.25 inches and/or any other subranges therebetween.

Additionally, in several embodiments, adjacent extractor blades 110 of the extractor blade assembly 110 may be circumferentially spaced apart from one another. For instance, as particularly shown in FIG. 4, a longitudinal centerline 116 of each extractor blade 110 (e.g., with the centerline extending in the radial direction through the rotational center of the blade 110) may be spaced apart circumferentially from the longitudinal centerline 116 of an adjacent extractor blade 110 by a given circumferential spacing angle 118. In one embodiment, the circumferential spacing angle 118 may range from greater than zero degrees to 90 degrees, such as from greater than zero degrees to 45 degrees or from greater than zero degrees to 25 degrees or from 45 degrees to 90 degrees or from 70 degree to 90 degree and/or any other subranges. For example, in the illustrated embodiment, the longitudinal centerlines 116 of neighboring or adjacent extractor blades 110 are spaced circumferentially by a circumferential spacing angle 118 of approximately 45 degrees.

As will be described below, each extractor blade 110 may include one or more suction portions and one or more cutter portions. The suction portion(s) of each extractor blade 110 may be configured to generate a suction force or vacuum sufficient to pick up the debris 53 (FIG. 2) relative to the cut billets 51 (FIG. 2) and force the debris 53 through the primary extractor 54. In this regard, the extractor blades 110 may be configured to collectively generate a suction force or vacuum similar to that of a conventional extractor fan. However, unlike a conventional extractor fan, each extractor blade 110 may be configured to generate a small pressure difference (e.g., as a relative fraction or percentage of the overall suction force). As such, the overall pressure differential within the extractor housing 84 may be spread out over a larger axial distance, which may facilitate maintaining the debris 53 in a more vertical orientation as it passes by the extractor blades 110 across such axial distance (and, thus, maintaining the debris 53 in a better orientation for cutting/shredding). Additionally, the cutter portion(s) of each extractor blade 110 may be configured to cut or shred the debris 53 directed through the extractor 54 via the suction force generated by the suction portions of the extractor blades 110. For instance, the cutter portion(s) of each extractor blade 110 may be characterized by a cutting edge (e.g., a sharpened edge) of each extractor blade 110 that is capable of slicing through or cutting/shredding the debris 53.

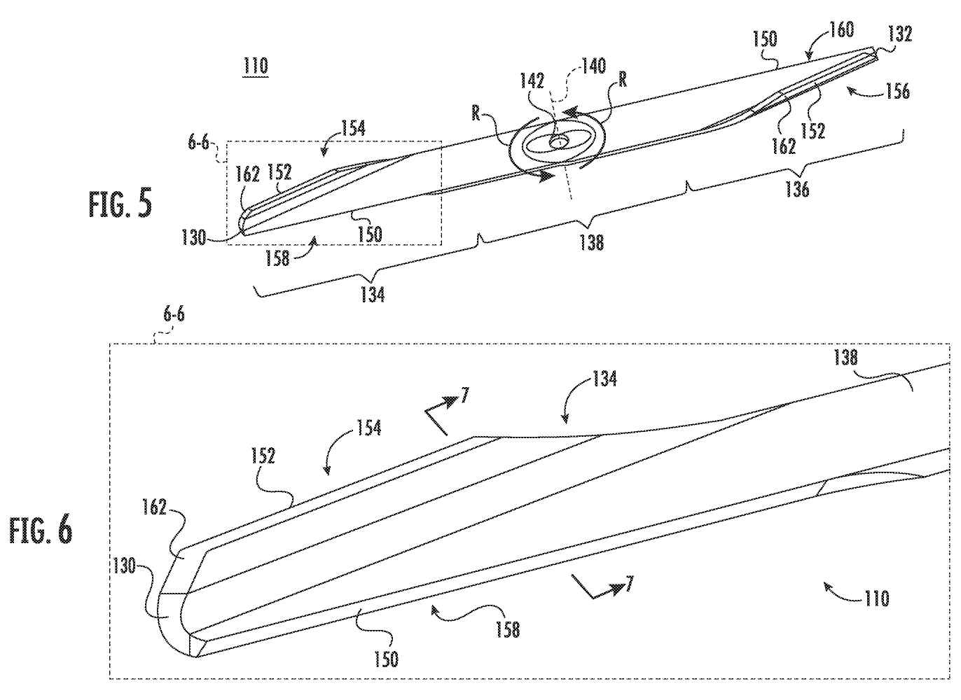

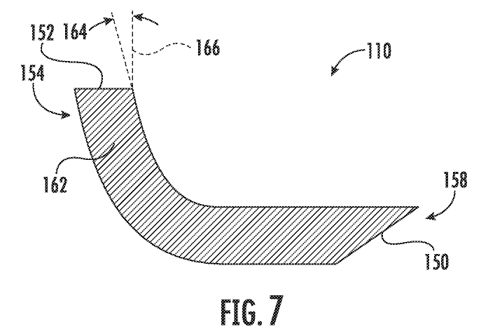

Referring now to FIGS. 5-7, various views of one embodiment of an extractor blade 110 suitable for use within the extractor blade assembly 100 described above are illustrated in accordance with aspects of the present subject matter. Specifically, FIG. 5 illustrates a perspective view of the extractor blade 110 and FIG. 6 illustrates a close-up, perspective view of a portion of the extractor blade 110 shown in box 6-6 in FIG. 5. Additionally, FIG. 7 illustrates a cross-sectional view of the portion of the extractor blade 110 shown in FIG. 6 taken about line 7-7.

As particularly shown in FIG. 5, the extractor blade 110 may generally extend lengthwise or longitudinally between a first end 130 and a second end 132 and may generally include first and second blade sections 134, 136 extending from the opposed ends 130, 132 of the extractor blade 110 to an intermediate or hub section 138 of the extractor blade 110. Specifically, the first blade section 134 generally extends radially inwardly (e.g., relative to an axial centerline 140 of the blade 110) from the first end 130 of the extractor blade 110 to the hub section 138 of the blade 110 and the second blade section 136 generally extends radially inwardly (e.g., relative to the axial centerline 140 of the blade 110) from the second end 132 of the extractor blade 110 to the hub section 138 of the blade 110, with the hub section 138 extending radially between the blade sections 134, 136 along either side of the blade’s axial centerline 140. In such an embodiment, the hub section 138 may generally be configured to be coupled to the shaft 102 (FIG. 3) of the extractor blade assembly 100 so that the axial centerline 140 of the extractor blade 110 is aligned coaxially with the rotational axis 112 of the shaft 102. For instance, as shown in FIG. 5, a shaft opening 142 may be defined through the center of the hub section 138 for receiving the shaft 102 (and for coupling the blade 110 to the shaft 102).

Each blade section 110 may generally include a leading edge 150 and a trailing edge 152 relative to the rotational direction of the extractor blade 110 (e.g., as indicated by arrows R in FIG. 5). Additionally, each blade section 110 may include a suction portion 154, 156 and a cutter portion 158, 160. For instance, as shown in the illustrated embodiment, the first blade section 134 may generally include a first suction portion 154 and first cutter portion 158, while the second blade section 136 may generally include a second suction portion 156 and a second cutter portion 160, with such blade portions 154, 156, 158, 160 generally being configured to function as described above. For instance, the suction portions 154, 156 of the extractor blade 110 may be configured to generate a suction force or vacuum for drawing debris through the associated extractor, while the cutter portions 158, 160 of the extractor blade 110 may be configured to cut or shred such debris.

As shown in the illustrated embodiment, the cutter portions 158, 160 of the extractor blade 110 may be positioned at the leading edges 150 of the blade sections 134, 136, thereby allowing such portions 158, 160 of the blade 110 to cut or shred debris as the blade 110 is rotated into contact therewith. In this regard, the leading edges 150 of the blade sections 134, 136 may, in several embodiments, correspond to cutting edges of the extractor blade 110. For instance, as particularly shown in FIG. 7, the leading edge 150 of each blade section 134, 136 may correspond to a sharpened edge or similar cutting edge. Specifically, in the illustrated embodiment, the leading edges 150 of the blade sections 134, 136 are configured as chisel cutting edges. However, in other embodiments, the leading edges 150 of the blade sections 134, 136 may be configured as any other suitable cutting edge type, such as a V-shaped cutting edge (e.g., straight, convex, and/or asymmetrical V-shaped edges), a compound or beveled cutting edge, and/or the like.

Additionally, to allow for the generation of the suction force or vacuum, the suction portions 154, 156 of the extractor blade 110 may be characterized by angled vane tabs 162 that extend from the trailing edges 152 of the blade sections 134, 136. For instance, as particularly shown in FIG. 7, as the extractor blade 110 extends from its leading, cutting edge 150 towards its trailing edge 152, the profile of the blade 110 transitions from a horizontal orientation to a more vertical orientation, thereby creating an angled vane tab 162 along the portion of the blade 110 extending adjacent to the trailing edge 152. As shown in the illustrated embodiment, the vane tab 162 may be oriented at a vane angle 164 relative to a reference plane 166 extending through and parallel to the rotational axis 112 of the extractor blade assembly 100 (also through and parallel to the axial centerline 140 of the blade 110). In one embodiment, the vane angle 164 of each vane tab 162 relative to the reference plane 166 may generally range from zero degrees to about 80 degrees, such as from zero degrees to about 60 degrees, or from zero degrees to about 40 degrees and/or any other subranges therebetween.

It should be appreciated that each vane tab 162 may generally be configured to generate a small pressure difference as the extractor blades 110 are being rotated. In this regard, by axially stacking or arranging multiple extractor blades 110 within the extractor housing 84, the vane tabs 162 (or suction portions 154, 156 generally) of the various blades 110 may collectively generate a substantial pressure difference, thereby allow for a sufficient suction force to be generated within the extractor housing 84 to extract debris from the flow of harvested materials output from the chopper assembly.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. An extractor for an agricultural harvester, the extractor comprising:
an extractor housing extending from an extractor inlet to an extractor outlet, the extractor housing configured to receive debris at the extractor inlet and direct the debris outwardly from the agricultural harvester at the extractor outlet;
an extractor blade assembly positioned within the extractor housing, the extractor blade assembly comprising a plurality of extractor blades, each extractor blade of the plurality of extractor blades having a cutting portion and a suction portion;
wherein, when the plurality of extractor blades are rotated in a rotational direction within the extractor housing:
the suction portion of each extractor blade is configured to generate a suction force within the extractor housing for directing the debris from the extractor inlet to the extractor outlet; and
the cutting portion of each extractor blade is configured to cut at least a portion of the debris being directed from the extractor inlet to the extractor outlet.

2. The extractor of claim 1, wherein each extractor blade comprises a leading edge and a trailing edge relative to the rotational direction of the plurality of extractor blades, the cutting portion of each extractor blade being positioned along the leading edge of the extractor blade and the suction portion of each extractor blade being positioned along the trailing edge of the extractor blade.

3. The extractor of claim 2, wherein the leading edge of each extractor blade is configured as a sharpened edge forming the cutting portion of the extractor blade.

4. The extractor of claim 2, wherein the suction portion of each extractor blade comprises a vane tab extending from the trailing edge of the extractor blade.

5. The extractor of claim 4, wherein the vane tab is oriented at a vane angle relative to a reference plane extending through and parallel to a rotational axis of the extractor blade assembly, the vane angle ranging from zero degrees to 80 degrees relative to the reference plane.

6. The extractor of claim 5, wherein the vane angle ranges from zero degrees to 40 degrees relative to the reference plane.

7. The extractor of claim 1, wherein a longitudinal centerline of each extractor blade is spaced apart circumferentially from the longitudinal centerline of an adjacent extractor blade of the plurality of extractor blades by a circumferential spacing angle, the circumferential spacing angle ranging from greater than zero degrees to 90 degrees.

8. The extractor of claim 1, wherein each extractor blade comprises first and second blade sections and a hub section extending between the first and second blade sections, the cutting portion of each extractor blade comprising a first cutting portion associated with the first blade section and a second cutting portion associated with the second blade section, the suction portion of each extractor blade comprising a first suction portion associated with the first blade section and a second suction portion associated with the second blade section.

9. The extractor of claim 1, wherein the plurality of extractor blades are stacked axially along a rotational axis of the extractor blade assembly.

10. The extractor of claim 1, further comprising a rotational drive member extending along a rotational axis within the extractor housing and being configured to be coupled to a rotational drive source for rotationally driving the rotational drive member about the rotational axis, wherein each extractor blade is coupled to and extends radially outward from the rotational drive member.

11. An extractor for an agricultural harvester, the extractor comprising:
an extractor housing extending from an extractor inlet to an extractor outlet, the extractor housing configured to receive debris at the extractor inlet and direct the debris outwardly from the agricultural harvester at the extractor outlet;
a rotational drive member extending along a rotational axis within the extractor housing and being configured to be coupled to a rotational drive source for rotationally driving the rotational drive member about the rotational axis;
an extractor blade assembly comprising a plurality of extractor blades coupled to and extending radially outward from the rotational drive member, each extractor blade of the plurality of extractor blades comprising first and second blade sections and a hub section extending between the first and second blade sections, the first blade section of each extractor blade including a first cutting portion and a first suction portion and the second blade section of each extractor blade including a second cutting portion and a second suction portion, the hub section of each extractor blade being coupled to the rotational drive member;
wherein, when the plurality of extractor blades are rotated via rotation of the rotational drive member:
the first and second suction portions of each extractor blade are configured to generate a suction force within the extractor housing for directing the debris from the extractor inlet to the extractor outlet; and
the first and second cutting portions of each extractor blade are configured to cut at least a portion of the debris being directed from the extractor inlet to the extractor outlet.

12. The extractor of claim 11, wherein each of the first and second blade sections of each extractor blade comprises a leading edge and a trailing edge relative to the rotational direction of the plurality of extractor blades, the first and second cutting portions of each extractor blade being positioned along the respective leading edges of the first and second blade sections and the first and second suction portions of each extractor blade being positioned along the respective trailing edges of the first and second blade sections.

13. The extractor of claim 12, wherein the leading edges of the first and second blade sections are configured as sharpened edges forming the first and second cutting portion of the extractor blade.

14. The extractor of claim 12, wherein each of the first and second suction portions of each extractor blade comprises a vane tab extending from the respective trailing edges of the first and second blade sections.

15. The extractor of claim 14, wherein each vane tab is oriented at a vane angle relative to a reference plane extending through and parallel to the rotational axis, the vane angle ranging from zero degrees to 80 degrees relative to the reference plane.

16. The extractor of claim 15, wherein the vane angle ranges from zero degrees to 40 degrees relative to the reference plane.

17. The extractor of claim 11, wherein a longitudinal centerline of each extractor blade is spaced apart circumferentially from the longitudinal centerline of an adjacent extractor blade of the plurality of extractor blades by a circumferential spacing angle, the circumferential spacing angle ranging from greater than zero degrees to 90 degrees.

18. The extractor of claim 11, wherein the plurality of extractor blades are stacked axially along the rotational axis.

19. An agricultural harvester, comprising:
a chopper assembly configured to process harvested materials;
an extractor configured to extract debris from a flow of processed harvested materials output from the chopper assembly, the extractor comprising:
an extractor housing extending from an extractor inlet to an extractor outlet, the extractor housing configured to receive the debris at the extractor inlet and direct the debris outwardly from the agricultural harvester at the extractor outlet;
an extractor blade assembly positioned within the extractor housing, the extractor blade assembly comprising a plurality of extractor blades, each extractor blade of the plurality of extractor blades having a cutting portion and a suction portion;
wherein, when the plurality of extractor blades are rotated in a rotational direction within the extractor housing:
the suction portion of each extractor blade is configured to generate a suction force within the extractor housing for directing the debris from the extractor inlet to the extractor outlet; and
the cutting portion of each extractor blade is configured to cut at least a portion of the debris being directed from the extractor inlet to the extractor outlet.

20. The agricultural harvester of claim 19, wherein the harvester comprises a sugarcane harvester and wherein the extractor comprises a primary extractor of the sugarcane harvester.
